(19) United States
(12) Patent Application Publication
(10) Pub. No.: US 2003/0186693 A1
(43) Pub. Date: Oct. 2, 2003

(54) Estimating traffic distribution in a mobile communication network

(76) Inventors: Gil Shafran, Jerusalem (IL); Boris Friydin, Rehovot (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/214,852

(22) Filed: Aug. 7, 2002

Related U.S. Application Data
(60) Provisional application No. 60/369,368, filed on Apr. 1, 2002.

(51) Int. Cl. H04Q 7/20

(52) U.S. Cl. 455/423; 455/446

(57) ABSTRACT

A method for estimating traffic distribution in a mobile communication network includes collecting statistical information with regard to a quantity of communication traffic and with regard to a quality indicator associated with the traffic in a region served by the mobile communication network. The region is divided into areas belonging to respective traffic types. A respective traffic density is estimated for each of the traffic types based on the statistical information collected with regard to the quantity of the traffic and the quality indicator.

### CROSS-REFERENCE TO RELATED APPLICATION

This application claims the benefit of U.S. provisional patent application No. 60/369,368, filed Apr. 1, 2002, which is incorporated herein by reference.

### COMPUTER PROGRAM LISTING APPENDIX

A computer program listing appendix is submitted herewith on one compact disc and one duplicate compact disc. The total number of compact discs including duplicates is two. The file on the compact disc is a Microsoft Excel® worksheet named traffDistrib.xls, created Jun. 25, 2002, of length 565,248 bytes.

### FIELD OF THE INVENTION

The present invention relates generally to optimization of resource use in mobile communication networks, and specifically to estimation of traffic distribution in such networks.

### BACKGROUND OF THE INVENTION

Service quality in cellular voice networks is typically measured by a number of key performance indicators:

System coverage—the geographic extent over which the network will reliably provide service. This indicator relates not only to the region over which the network extends, but also the existence of local coverage “holes.”

Call blockage—the percentage of attempts to make or receive calls that are blocked due to lack of available voice channels. Inadequate system capacity leads to high blockage rates.

Voice quality—the level of noise and/or distortion in voice conversations, typically measured in terms of bit error rate (BER), Frame Erasure Rate (FER) and/or Received Level Quality (RxQual).

Dropped call rate—percentage of calls in progress that terminate before either party intentionally ends the call.

Similar concerns as to coverage, capacity and error rate exist in wireless packet data networks, although in this case the key performance indicators relate to whether an online connection is available to the user and the effective throughput (data rate) of the connection.

The key performance indicators are themselves dependent on characteristics of the underlying radio network that is used to carry the voice or data signals. Each cell in the network has one or more antennas that are meant to serve mobile units (cellular telephones and/or data terminals) within its service area. The strength of the signals reaching the mobile units from the antennas, and vice versa, are determined by the path loss of electromagnetic waves propagating between the antennas and the mobile unit locations. If the received signal level at a given location is too low, poor quality or coverage holes will result. In planning cellular networks, path loss maps are typically used to locate the antennas and determine the power levels needed to avoid such holes.

Each cell in a narrowband cellular network is assigned a fixed set of frequencies. (Narrowband networks include Time Division Multiple Access [TDMA] networks, such as Global System for Mobile [GSM] communication networks. Code Division Multiple Access [CDMA] networks assign a broad frequency band to each cell.) When a mobile unit initiates or receives a call, it is assigned to one of the frequencies of the serving cell. If there is no frequency available—due typically to traffic in the area of the mobile unit that is in excess of the capacity of the cell—the call will be blocked. When a mobile unit, such as a cellular telephone in a car, moves within the network service region, it may be handed over from one cell to another. If the new cell does not have a frequency available, the call will be dropped.

Thus, in planning the location and configuration of antennas and the allocation of frequencies in a cellular network, it is important to take into account the distribution of communication traffic in every area of the network service region. Each cell should have sufficient frequency allocation to accommodate the expected number of mobile units in its service area, so that blocked and dropped calls are minimized. On the other hand, because frequency spectrum is a scarce resource in cellular networks, excess, wasted capacity should be avoided, as well. Therefore, cellular network operators need accurate traffic distribution information in order to optimize the key performance indicators of their networks.

A number of methods are known in the art for estimating network traffic distribution. One method is to trace the location and performance of individual mobile units in the network. Typically, a small number of special mobile units with geographical locating capabilities are used for this purpose. Alternatively, measurements may be made using larger numbers of ordinary mobile units, by estimating the position of each mobile unit based on signal strength measurements. In either case, the measurements are cumbersome and have low statistical reliability.

An alternative method for estimating traffic distribution is to use traffic statistics provided by the network itself. The statistics indicate the amount of traffic served by each cell in the network during a given measurement period. The statistical information can be used to estimate the traffic density for each of a number of different “clutter types” in the service region, such as urban areas, roads and open space. The problem with this method, however, is that the granularity of the collected information is coarse, consisting only of the total traffic per cell. Therefore, the traffic density calculated in this manner gives only a very rough estimate of the actual traffic in any particular location in the network coverage region.

### SUMMARY OF THE INVENTION

It is an object of some aspects of the present invention to provide improved methods and systems for estimating traffic distribution in a mobile communication network.

Cellular networks regularly gather statistical data from each cell not only on the amount of traffic served, but also with regard to various indicators of the quality of calls carried by the cell. These quality indicators include, for example, the average carrier/interference (C/I) ratio, specific levels of interference from other cells, and frequency of handovers between cells. In preferred embodiments of the present invention, these quality indicators are used together with the measured quantity of traffic carried by each cell to map the actual traffic density in the network. The use of the quality statistics in the calculation allows the network service region to be divided into clutter classifications with much finer granularity than can be achieved by methods known in the art. The resulting traffic density map is thus more accurate and true to reality, allowing better optimization of the antenna configurations and frequency distribution among the cells.

There is therefore provided, in accordance with a preferred embodiment of the present invention, a method for estimating traffic distribution in a mobile communication network, including:

collecting statistical information with regard to a quantity of communication traffic and with regard to a quality indicator associated with the traffic in a region served by the mobile communication network;

dividing the region into areas belonging to respective traffic types; and

estimating a respective traffic density for each of the traffic types based on the statistical information collected with regard to the quantity of the traffic and the quality indicator.

Typically, the network includes a plurality of fixed transceivers at respective locations in the region, and collecting the statistical information includes collecting the information from the fixed transceivers with respect to the communication traffic exchanged over the air between the fixed transceivers and mobile units served by the network. In a preferred embodiment, the network includes a cellular network, and collecting the information from the fixed transceivers includes collecting the information with respect to cells in the network that are served by the fixed transceivers. Preferably, collecting the information with regard to the quality indicator includes collecting statistics regarding handoffs between the cells. Alternatively or additionally, dividing the region includes dividing the region into bins, associating the bins with respective clutter types, and defining each of the traffic types by grouping together all the bins that belong a respective one of the clutter types and are all served by a respective one of the cells.

In a preferred embodiment, measuring time delays in transmission of the communication traffic between the fixed transceivers and the mobile units, and estimating the respective traffic density includes using the time delays in determining the traffic density.

In a further preferred embodiment, collecting the information includes measuring an effect of interference by a first one of the fixed transceivers on the traffic exchanged between the mobile units and a second one of the fixed transceivers. Preferably, measuring the effect includes collecting statistics regarding carrier/interference values in the traffic exchanged between the mobile units and the second one of the fixed transceivers. Alternatively or additionally, measuring the effect includes determining an element of an impact matrix relating the first and second ones of the fixed transceivers. Further alternatively or additionally, measuring the effect includes collecting statistics regarding dropped call rates.

Typically, the method includes optimizing a configuration of the fixed transceivers responsive to the estimated traffic density. In a preferred embodiment, optimizing the configuration includes distributing operating frequencies among the fixed transceivers responsive to the estimated traffic density.

Preferably, collecting the statistical information with regard to the quality indicator includes collecting statistics with regard to a signal/noise ratio associated with the traffic. Additionally or alternatively, collecting the statistical information with regard to the quality indicator includes collecting statistics with regard to a power level of received signals used in carrying the traffic.

Preferably, dividing the region includes dividing the region into bins, associating the bins with respective clutter types, and defining each of the traffic types by grouping together all the bins in mutual proximity that belong a respective one of the clutter types. Alternatively or additionally, dividing the region includes defining the areas in accordance with a grid imposed on the region.

Typically, the communication traffic includes at least one of voice traffic and packet data traffic.

There is also provided, in accordance with a preferred embodiment of the present invention, apparatus for estimating traffic distribution in a mobile communication network, including a computer, which is coupled to collect statistical information with regard to a quantity of communication traffic and with regard to a quality indicator associated with the traffic in a region served by the mobile communication network, wherein the region is divided into areas belonging to respective traffic types, the computer is adapted to estimate a respective traffic density for each of the traffic types based on the statistical information collected with regard to the quantity of the traffic and the quality indicator.

There is additionally provided, in accordance with a preferred embodiment of the present invention, a computer software product for estimating traffic distribution in a mobile communication network, the product including a computer-readable medium in which program instructions are stored, which instructions, when read by a computer, cause the computer to receive statistical information collected with regard to a quantity of communication traffic and with regard to a quality indicator associated with the traffic in a region served by the mobile communication network, wherein the region is divided into areas belonging to respective traffic types, and wherein the instructions cause the computer to estimate a respective traffic density for each of the traffic types based on the statistical information collected with regard to the quantity of the traffic and the quality indicator.

The present invention will be more fully understood from the following detailed description of the preferred embodiments thereof, taken together with the drawings in which:

### BRIEF DESCRIPTION OF THE DRAWINGS

FIG. 1 is a schematic, pictorial view of a region served by a cellular communication network, in accordance with a preferred embodiment of the present invention; and

FIG. 2 is a flow chart that schematically illustrates a method for estimating traffic distribution in a cellular communication network, in accordance with a preferred embodiment of the present invention.

### DETAILED DESCRIPTION OF PREFERRED EMBODIMENTS

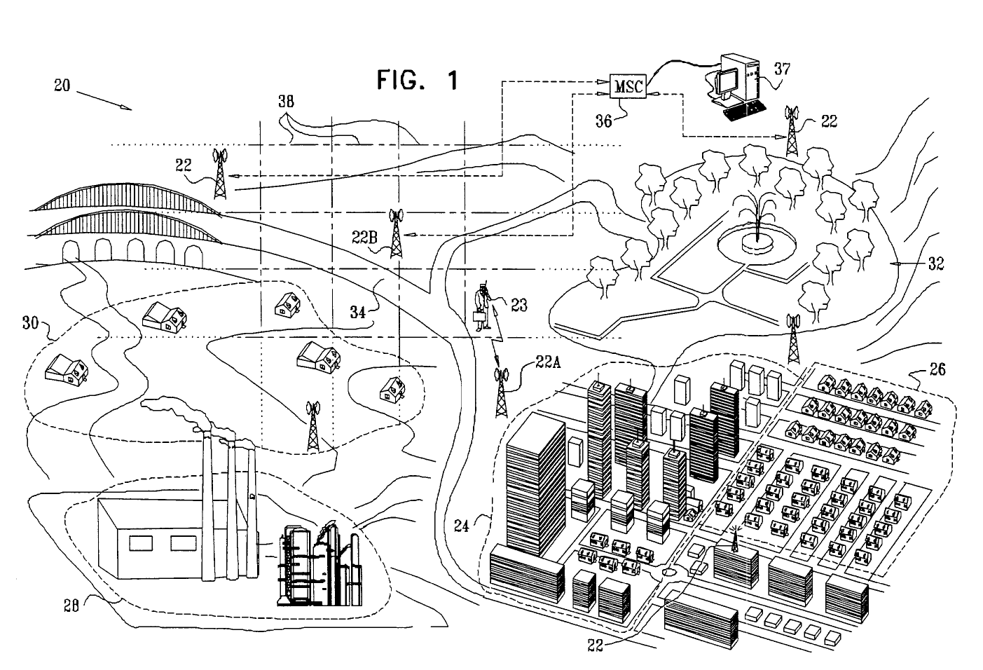

FIG. 1 is a schematic, pictorial view of a region 20 served by a cellular communication network, which is optimized in accordance with a preferred embodiment of the present invention. For the purposes of the cellular network, region 20 is divided into partly-overlapping cells, as is known in the art, each served by one or more fixed transceivers, represented by antennas 22. By way of example, an antenna 22A serves a cell, which will be referred to as cell A, in which a mobile unit 23 is being used to carry on a telephone call. Another antenna 22B serves a neighboring or nearby cell, which will be referred to as cell B. In the description that follows, cells A and B will be used to exemplify the possible influences of one cell (cell B) on the communication quality experienced by mobile units in another cell (cell A). In the course of a telephone call, particularly while traveling, mobile unit 23 may be handed off from cell A to cell B, meaning that antenna 22B serves the mobile unit in place of antenna 22A.

Region 20 is characterized by a number of different clutter types, for example, a dense urban area 24, an urban residential area 26, an industrial area 28, a rural area 30, open space 32 and a highway 34. Each of these areas, clearly, will have its own characteristic traffic density. Furthermore, sub-areas within these predefined clutter types may have their own density characteristics, depending on the particular nature and uses of the structures and other features in these sub-areas. Thus, in principle, each clutter type encountered in region 20 may be broken into sub-types corresponding to these sub-areas. Preferred embodiments of the present invention, as described below, provide methods for defining these sub-types and determining their traffic density characteristics. The traffic density served by any given antenna 22 will be a function of the sub-types and sizes of the sub-areas that fall within the cell served by the particular antenna.

Communication traffic in the cellular network serving region 20 is controlled and routed among antennas 22 by a mobile switching center (MSC) 36, as is known in the art. Typically, the MSC also collects traffic density and quality statistics from every cell in region 20. Alternatively, these statistics may be collected by another management element in the cellular network. Different types of quality statistics that may be used for the purposes of the present invention are described below. The traffic density and quality statistics are passed to a computer 37 for analysis, along with other information concerning the network configuration. This other information may include, for example, the configurations of antennas 22, such as their frequency allocations, locations, height, transmission power, azimuth and tilt; geographical features of region 20; and path loss maps, showing the attenuation of electromagnetic waves propagating between each of the antennas and different mobile unit locations in region 20.

Computer 37 processes the per-cell traffic density and quality statistics for all the cells in region 20 in order to arrive at a traffic density estimate for each of the clutter sub-types in the region. To this end, region 20 is divided into bins 38, each comprising a small geographical area, preferably much smaller than the size of a cell. Bin sizes may typically be set between 20×20 m and 300×300 m, although larger or smaller bins may also be used, depending on application requirements. The bins are grouped together into sets corresponding to different clutter sub-types, and the characteristic sub-type traffic densities are then estimated, in a manner described below. The computer performs these functions under the control of software supplied for this purpose. The software may be conveyed to the computer in electronic form, over a network, for example, or it may be furnished on tangible media, such as CD-ROM.

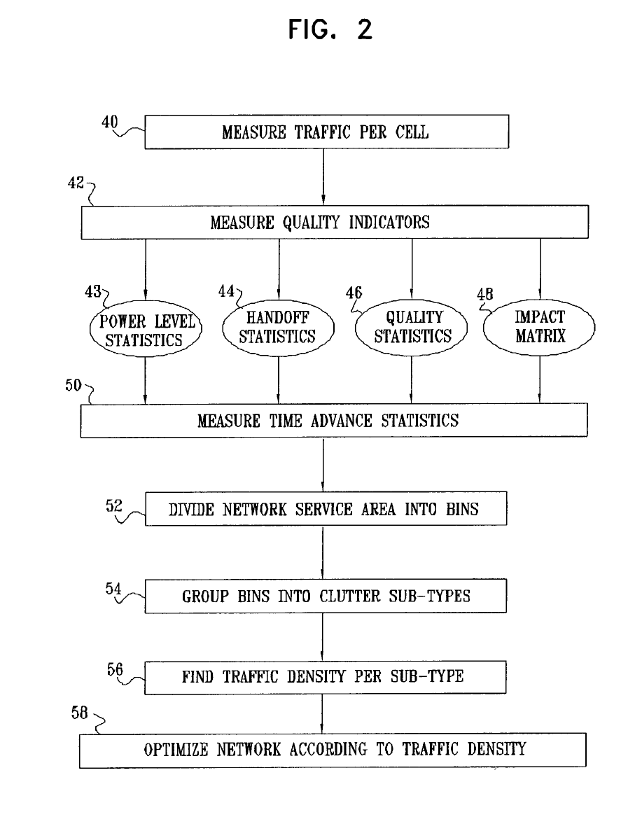

FIG. 2 is a flow chart that schematically illustrates a method for estimating the traffic density by sub-type in region 20, in accordance with a preferred embodiment of the present invention. For each cell in the region, computer 37 receives a measure of the traffic density in that cell, at a traffic measurement step 40. The traffic density is typically expressed in units of Erlangs, corresponding to one hour of call time per temporal hour. For any given cell, say cell A, the total traffic density T(A) is given by:

$$T ( A ) = {\sum }_{x ∈ X} T ( x ) p ( S ( A , x ) ) \qquad ( 1 )$$

Here T(x) is the traffic density in bin x, wherein X is the set of all bins in region 20, and p(S(A,x)) is the probability that cell A serves mobile unit 23 in bin x. T(x) is a random variable, which at this point is unknown, but is assumed to be non-negative. An exemplary method for calculating p(S(A,x)) is described in the above-mentioned provisional patent application. The sum of p(S(Y,x)) over all cells Y in region 20 should be one (or zero in uncovered bins).

In order to be able to estimate T(x), computer 37 also receives one or more quality indicators collected from antennas 22 by MSC 36, at a quality measuring step 42. Preferably, the following indicators are used:

Received power level statistics. For a given cell A, the global received power level density is related to the local power level density R(A,x) in each bin x by the expression:

$$p ( R ( R , X ) = b ) = \frac{1}{T ( A )} {\sum }_{x ∈ X} T ( x ) p ( S ( A , x ) ) p ( R ( A , x ) = b ) \qquad ( 2 )$$

R(A,x) is a random variable, preferably discrete-valued, which represents the signal strength of cell A in bin x.

Handoff statistics 44. For a given cell A, the global handoff density to any other cell, say cell B, is represented by H (A→B,X), corresponding to the number of handoffs from cell A to cell B per unit time over all of set X. Handoffs are coordinated and monitored by MSC 36. The global handoff density is related to the local handoff density H(A→B,x) in each bin x by the expression:

$$p ( H ( A \to B , X ) ) = \frac{1}{T ( A )} {\sum }_{x ∈ X} T ( x ) p ( S ( A , x ) ) p ( H ( A \to B , x ) ) \qquad ( 3 )$$

H(A→B,x) is a random variable, which depends on the signal strengths of cells A and B in bin x and the criteria used in the cellular network to decide when a handoff should take place. Methods for calculating H are similarly described in the above-mentioned provisional and regular patent applications.

Quality statistics 46. Each mobile unit 23 suffers from some interference, resulting in a carrier/interference (C/I) value that represents the strength of the carrier signal received by the mobile unit from its serving cell, compared to the strength of the interfering signals received from other cells in region 20 at the same frequency. C/I, in other words, is a specific sort of signal/noise ratio. The C/I ratio experienced by a mobile unit determines the quality of its calls. The call quality is typically measured in terms of quality parameters Q(A,x), such as BER (bit error rate), FER (frame erasure rate) or RxQual (received level quality), as mentioned above. The mobile units report their call quality values to their serving cells. These values are aggregated by MSC 36 to compute the global quality histogram for cell A, Q(A,X), corresponding to the probability that a mobile unit served by cell A anywhere in region 20 will measure some call quality b. The global quality parameters are related to local quality variable for each bin x, Q(A,x), by the expression:

$$p ( Q ( A , X ) = b ) = \frac{1}{T ( A )} {\sum }_{x ∈ X} T ( x ) p ( S ( A , x ) ) p ( Q ( A , x ) = b ) \qquad ( 4 )$$

Dropped calls. Each mobile unit served by the cellular system and suffering from some interference may become subject to the cellular system drop call mechanism. Cellular systems keep record of drop rates of calls served by each cell. These dropped call rates can thus be considered another form of quality statistics. The global drop call parameters are related to a local drop call variable D(A,x) for each bin x by the expression:

$$p ( D ( A , X ) ) = \frac{1}{T ( A )} {\sum }_{x ∈ X} T ( x ) p ( S ( A , x ) ) p ( D ( A , x ) ) \qquad ( 5 )$$

The calculations of drop probabilities take into account channel allocation and technology-dependent mechanisms for dropping calls.

Impact matrix 48. Each element of this matrix corresponds to the interference probability between a pair of cells A and B, assuming that both cells use the same frequency. In other words, the matrix element IM(B→A,X) represents the percentage of traffic served by cell A that would be damaged (typically by reducing the C/I ratio to below some chosen threshold) due to interference from cell B under such conditions. The impact matrix elements for cell A can be determined by computer 37 based on measurements made by mobile units in the area of cell A of the relative signal strengths received from other cells. Such signal strength data are commonly assembled by mobile units and reported to MSC 36 for use in deciding when a given mobile unit should be handed off to a new cell (mobile-assisted handoff). The impact matrix elements may also be computed based on C/I statistics 46. The global impact matrix elements are related to the local elements IM(B→A,x) by the expression:

$$IM ( B \to A , x ) = \frac{1}{T ( A )} {\sum }_{x ∈ X} T ( x ) p ( S ( A , x ) ) IM ( B \to A , x ) \qquad ( 6 )$$

In addition to one or more of these quality indicators, computer 37 also receives timing advance statistics for each cell in region 20, at a time measurement step 50. “Timing advance” is a term used in GSM networks to refer to the delay t between the time of transmission of a signal from antenna 22 and the time of its reception by mobile unit 23 (or vice versa). Similar measurements may be made in other types of mobile communication networks. The time delay t is proportional to the distance d between the antenna and the mobile unit. A terrain map is preferably used in translating timing advance into distance from a site. Timing advance measurements may thus be used to determine the distance between the antenna 22 of the serving cell and the bin 38 in which mobile 23 is located while served by the cell. We define the timing advance variable TA(A,d) to be equal to the number of transmissions received or transmitted in cell A during a given time period from or to mobile units at distance d from the antenna. This variable is related to the per-bin traffic density by the expression:

$$TA ( A , d ) = {\sum }_{( x ∈ X \vert dist ( x , A ) = d )} T ( x ) p ( S ( A , x ) ) \qquad ( 7 )$$

In order to determine traffic density for different clutter sub-types occurring in region 20, the region is divided up into bins 38, at a binning step 52, as described above. The bins are then grouped into different clutter sub-types, at a bin grouping step 54. Various criteria may be used to define the sub-types within a given clutter type, for example:

Region 20 may be divided by a grid, such as a latitude/longitude or UTM grid. All bins 38 of a given clutter type within the same square of the grid are defined as belonging to the same sub-type.

Each bin 38 may be classified according to the best-serving cell, i.e., the cell (or antenna 22) having the highest probability of serving mobile units 23 in that bin (typically due to factors such as antenna signal strengths and handoff parameters). All bins of a given clutter type that belong to the same best-serving cell are defined as belonging to the same sub-type.

Sets of mutually-adjacent bins 38 of the same clutter type may be clustered together to define sub-types. Preferably, the size of each set is limited by restricting the maximum distance between any two bins in the set.

Alternatively, other criteria may be used to define sub-areas and sub-types within region 20. The term “sub-type” should therefore be understood to refer not only to areas having different types of clutter characteristics, but more broadly to encompass any classification of bins 38 that can be used to differentiate areas and sub-areas by traffic density.

Computer 37 processes the global traffic statistics and quality indicators for each cell in order to find the specific traffic density for each clutter sub-type, at an analysis step 56. The inputs to this calculation are the measured values of T(A), along with one or more of H (A→B, X), R (A, X), Q(A, X), IM (B→A, X) and TA (A, d), as measured for all cells A and B in region 20. The measured values are inserted into equations (1) through (5), as appropriate. The bin traffic density value variable in each equation is replaced by the applicable sub-type traffic density, i.e., T(x)=T(sub-type(x)). The set of equations thus obtained is inverted to find T(sub-type(x)) for all the sub-types chosen at step 54. The sub-type traffic densities are preferably adjusted, if necessary, to maintain continuity of the local traffic density among neighboring bins, since it is expected that the traffic density will not change abruptly from one bin to the next.

Once the traffic density for each clutter sub-type is known, the density values can be mapped back to bins 38 according to their respective sub-types. This mapping is typically used in optimizing the operating configuration of antennas 22, at an optimization step 58. The frequencies allocated to the different cells in region 20 may be changed, based on the traffic density map, to give better coverage in bins where there is dense traffic, while possibly reducing wasted over-allocation in areas of sparse traffic. Other factors, such as the height, transmission power, azimuth and tilt of the antennas may also be adjusted, and extra antennas may be added in problematic areas.

The computer program listing appendix to this application contains a Microsoft Excel spreadsheet file, which illustrates computer analysis of traffic statistics and quality indicators in order to find specific sub-type clutter densities. The spreadsheet file can be opened and operated using Excel version 2000 (Microsoft Corporation, Redmond, Wash.), running on a personal computer with a Pentium III processor and the Windows 2000 operating system. The Excel “Solver” tool should be installed according to the instructions provided with the spreadsheet software.

Upon opening the spreadsheet, the user will see a clutter map at upper left, defining a number of different clutter types and sub-types that are spread over a geographical area of interest. The map is divided into a grid of 20×20 bins. The map layout can be varied by changing the underlying numerical values. Below the clutter map, at the left side of the spreadsheet, are power maps showing power received from three different antennas, identified as A, B and C, as a function of location. The received antenna powers may similarly be modified by changing the underlying numerical values. In actual operation, the values in the clutter and power maps would typically be determined by values of these parameters measured in the field or taken from existing maps and models.

At the right of the spreadsheet, a table of “switch-measured values” contains values of traffic density (in Erlangs) served by each of antennas A, B and C, as well as impact matrix and handoff probability elements for each pair of the antennas. In actual operation, these values would be derived from operational data gathered by a cellular network switch serving the antennas. In the spreadsheet, these values may be varied by the user. Further model parameters to be input by the user are provided in the tables at the upper right of the spreadsheet.

When the desired input values have been entered in the tables, the user should select Tools >Solver in the Excel menu, and should then click on the “Solve” button in the dialog box that appears. The Excel Solver will compute the clutter density per sub-type, and the computed values will appear in the clutter density table at the upper right of the spreadsheet. The sub-type clutter densities are calculated so as to minimize the differences between the switch-measured values of the traffic density, impact matrix and handoff probability (as input by the user) and the corresponding values of these parameters that are derived from the computational model. The model-derived parameters are calculated by mapping the computed clutter densities back to the individual bins. These calculations are performed iteratively until the Solver reaches a solution within predetermined convergence limits. The resulting traffic density, impact matrix elements and handoff probabilities per bin are shown for each antenna in the maps in the lower right-hand portion of the spreadsheet.

The techniques embodied in the attached spreadsheet may be extended in a straightforward manner to larger and more complex systems. Alternatively, other methods for solving sets of constraints may be used in this context, as will be apparent to those skilled in the art.

Although in the preferred embodiments described above, certain particular quality statistics are used in building estimates of traffic distribution, the principles of the present invention are not limited to this set of statistical indicators. Other quality measures that may be used in this context will be apparent to those skilled in the art. In particular, while some of the quality indicators measured at step 42 in the method of FIG. 2 are specifically characteristic of cellular voice communications, the same method may easily be adapted for use in wireless packet data networks. In such networks, switch statistics such as data throughput and delay are routinely measured and can be used in extracting traffic distribution information in a manner substantially similar to that described above. Furthermore, whereas certain of the quality statistics used in these preferred embodiments are specific to narrowband cellular networks, the principles of the present invention may also be applied to other types of mobile communication networks, including broadband cellular networks, such as CDMA-based systems.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for estimating traffic distribution in a mobile communication network, comprising:
collecting statistical information with regard to a quantity of communication traffic and with regard to a quality indicator associated with the traffic in a region served by the mobile communication network;
dividing the region into areas belonging to respective traffic types; and
estimating a respective traffic density for each of the traffic types based on the statistical information collected with regard to the quantity of the traffic and the quality indicator.

2. A method according to claim 1, wherein the network comprises a plurality of fixed transceivers at respective locations in the region, and wherein collecting the statistical information comprises collecting the information from the fixed transceivers with respect to the communication traffic exchanged over the air between the fixed transceivers and mobile units served by the network.

3. A method according to claim 2, wherein the network comprises a cellular network, and wherein collecting the information from the fixed transceivers comprises collecting the information with respect to cells in the network that are served by the fixed transceivers.

4. A method according to claim 3, wherein collecting the information with regard to the quality indicator comprises collecting statistics regarding handoffs between the cells.

5. A method according to claim 3, wherein dividing the region comprises dividing the region into bins, associating the bins with respective clutter types, and defining each of the traffic types by grouping together all the bins that belong a respective one of the clutter types and are all served by a respective one of the cells.

6. A method according to claim 2, and comprising measuring time delays in transmission of the communication traffic between the fixed transceivers and the mobile units, and wherein estimating the respective traffic density comprises using the time delays in determining the traffic density.

7. A method according to claim 2, wherein collecting the information comprises measuring an effect of interference by a first one of the fixed transceivers on the traffic exchanged between the mobile units and a second one of the fixed transceivers.

8. A method according to claim 7, wherein measuring the effect comprises collecting statistics regarding carrier/interference values in the traffic exchanged between the mobile units and the second one of the fixed transceivers.

9. A method according to claim 7, wherein measuring the effect comprises determining an element of an impact matrix relating the first and second ones of the fixed transceivers.

10. A method according to claim 7, wherein measuring the effect comprises collecting statistics regarding dropped call rates.

11. A method according to claim 2, and comprising optimizing a configuration of the fixed transceivers responsive to the estimated traffic density.

12. A method according to claim 11, wherein optimizing the configuration comprises distributing operating frequencies among the fixed transceivers responsive to the estimated traffic density.

13. A method according to claim 1, wherein collecting the statistical information with regard to the quality indicator comprises collecting statistics with regard to a signal/noise ratio associated with the traffic.

14. A method according to claim 1, wherein collecting the statistical information with regard to the quality indicator comprises collecting statistics with regard to a power level of received signals used in carrying the traffic.

15. A method according to claim 1, wherein dividing the region comprises dividing the region into bins, associating the bins with respective clutter types, and defining each of the traffic types by grouping together all the bins in mutual proximity that belong a respective one of the clutter types.

16. A method according to claim 1, wherein dividing the region comprises defining the areas in accordance with a grid imposed on the region.

17. A method according to claim 1, wherein the communication traffic comprises voice traffic.

18. A method according to claim 1, wherein the communication traffic comprises packet data traffic.

19. Apparatus for estimating traffic distribution in a mobile communication network, comprising a computer, which is coupled to collect statistical information with regard to a quantity of communication traffic and with regard to a quality indicator associated with the traffic in a region served by the mobile communication network, wherein the region is divided into areas belonging to respective traffic types, the computer is adapted to estimate a respective traffic density for each of the traffic types based on the statistical information collected with regard to the quantity of the traffic and the quality indicator.

20. Apparatus according to claim 19, wherein the network comprises a plurality of fixed transceivers at respective locations in the region, and wherein the statistical information is provided by the fixed transceivers with respect to the communication traffic exchanged over the air between the fixed transceivers and mobile units served by the network.

21. Apparatus according to claim 20, wherein the network comprises a cellular network, and wherein the statistical information is provided with respect to cells in the network that are served by the fixed transceivers.

22. Apparatus according to claim 21, wherein the statistical information comprises statistics regarding handoffs between the cells.

23. Apparatus according to claim 21, wherein the region is divided into bins, which are associated with respective clutter types, and wherein each of the traffic types is defined by grouping together all the bins that belong a respective one of the clutter types and are all served by a respective one of the cells.

24. Apparatus according to claim 20, wherein the computer is adapted to receive measurements of time delays in transmission of the communication traffic between the fixed transceivers and the mobile units, and to estimate the respective traffic density using the time delays.

25. Apparatus according to claim 20, wherein the statistical information comprises statistics regarding an effect of interference by a first one of the fixed transceivers on the traffic exchanged between the mobile units and a second one of the fixed transceivers.

26. Apparatus according to claim 25, wherein the statistics comprise data regarding carrier/interference values in the traffic exchanged between the mobile units and the second one of the fixed transceivers.

27. Apparatus according to claim 25, wherein the computer is adapted to determine, responsive to the statistics, an element of an impact matrix relating the first and second ones of the fixed transceivers.

28. Apparatus according to claim 25, wherein the statistics comprise data regarding dropped call rates.

29. Apparatus according to claim 20, wherein the computer is adapted to determine an optimized configuration of the fixed transceivers responsive to the estimated traffic density.

30. Apparatus according to claim 29, wherein the optimized configuration comprises an optimized distribution of operating frequencies among the fixed transceivers based on the estimated traffic density.

31. Apparatus according to claim 19, wherein the statistical information with regard to the quality indicator comprises statistics with regard to a signal/noise ratio associated with the traffic.

32. Apparatus according to claim 19, wherein the statistical information with regard to the quality indicator comprises statistics with regard to a power level of received signals used in carrying the traffic.

33. Apparatus according to claim 19, wherein the region is divided into bins, the bins are associated with respective clutter types, and each of the traffic types is defined by grouping together all the bins in mutual proximity that belong a respective one of the clutter types.

34. Apparatus according to claim 19, wherein the region is divided into the areas in accordance with a grid imposed on the region.

35. Apparatus according to claim 19, wherein the communication traffic comprises voice traffic.

36. Apparatus according to claim 19, wherein the communication traffic comprises packet data traffic.

37. A computer software product for estimating traffic distribution in a mobile communication network, the product comprising a computer-readable medium in which program instructions are stored, which instructions, when read by a computer, cause the computer to receive statistical information collected with regard to a quantity of communication traffic and with regard to a quality indicator associated with the traffic in a region served by the mobile communication network, wherein the region is divided into areas belonging to respective traffic types, and wherein the instructions cause the computer to estimate a respective traffic density for each of the traffic types based on the statistical information collected with regard to the quantity of the traffic and the quality indicator.

38. A product according to claim 37, wherein the network comprises a plurality of fixed transceivers at respective locations in the region, and wherein the statistical information is provided by the fixed transceivers with respect to the communication traffic exchanged over the air between the fixed transceivers and mobile units served by the network.

39. A product according to claim 38, wherein the network comprises a cellular network, and wherein the statistical information is provided with respect to cells in the network that are served by the fixed transceivers.

40. A product according to claim 39, wherein the statistical information comprises statistics regarding handoffs between the cells.

41. A product according to claim 39, wherein the region is divided into bins, which are associated with respective clutter types, and wherein each of the traffic types is defined by grouping together all the bins that belong a respective one of the clutter types and are all served by a respective one of the cells.

42. A product according to claim 38, wherein the instructions cause the computer to receive measurements of time delays in transmission of the communication traffic between the fixed transceivers and the mobile units, and to estimate the respective traffic density using the time delays.

43. A product according to claim 38, wherein the statistical information comprises statistics regarding an effect of interference by a first one of the fixed transceivers on the traffic exchanged between the mobile units and a second one of the fixed transceivers.

44. A product according to claim 43, wherein the statistics comprise data regarding carrier/interference values in the traffic exchanged between the mobile units and the second one of the fixed transceivers.

45. A product according to claim 43, wherein the instructions cause the computer to determine, responsive to the statistics, an element of an impact matrix relating the first and second ones of the fixed transceivers.

46. Apparatus according to claim 43, wherein the statistics comprise data regarding dropped call rates.

47. A product according to claim 38, wherein the instructions cause the computer to determine an optimized configuration of the fixed transceivers responsive to the estimated traffic density.

48. A product according to claim 47, wherein the optimized configuration comprises an optimized distribution of operating frequencies among the fixed transceivers based on the estimated traffic density.

49. A product according to claim 38, wherein the statistical information with regard to the quality indicator comprises statistics with regard to a signal/noise ratio associated with the traffic.

50. A product according to claim 38, wherein the statistical information with regard to the quality indicator comprises statistics with regard to a power level of received signals used in carrying the traffic.

51. A product according to claim 38; wherein the region is divided into bins, the bins are associated with respective clutter types, and each of the traffic types is defined by grouping together all the bins in mutual proximity that belong a respective one of the clutter types.

52. A product according to claim 38, wherein the region is divided into the areas in accordance with a grid imposed on the region.

53. A product according to claim 38, wherein the communication traffic comprises voice traffic.

54. A product according to claim 38, wherein the communication traffic comprises packet data traffic.
